(19) United States
(12) Patent Application Publication
(10) Pub. No.: US 2021/0401668 A1
(43) Pub. Date: Dec. 30, 2021

(54) FOOD ARRANGEMENT

(71) Applicant: Fresenius Kabi Deutschland GmbH, Bad Homburg (DE)

(72) Inventors: Torsten Brandenburger, Reichelsheim (DE); Ismael Rahimy, Friedberg (DE)

(21) Appl. No.: 17/315,925

(22) Filed: May 10, 2021

Related U.S. Application Data
(63) Continuation of application No. 15/024,924, filed on Mar. 25, 2016.

(30) Foreign Application Priority Data
Sep. 25, 2013 (EP) 13185855.7

(51) Int. Cl. A61J 1/10; A61J 1/14; B65B 7/28; B65B 39/00; B65B 55/08; B65B 55/10; B65D 25/48; B65D 43/02; B65D 47/06; B65D 75/58; B65D 85/72

(52) U.S. Cl. CPC A61J 1/10; A61J 1/1418; A61J 1/1475; A61J 1/1443; A61J 1/1481; A61J 1/1412; B65B 7/28; B65B 39/007; B65B 55/08; B65B 55/10; B65D 25/48; B65D 43/0235; B65D 47/06; B65D 75/5872; B65D 85/72; A61J 1/1406

(57) ABSTRACT

A food arrangement with at least one receptacle which is filled with a liquid, sterile food; a connector, which is introduced into the receptacle and has a pierced membrane arranged in a filler neck; and a tamper-evident seal, which is connected to the connector and closes the filler neck. A sterile food arrangement is thus made available, without the need for final autoclaving of the entire filled receptacle.

### CROSS REFERENCE TO RELATED APPLICATIONS

This application is a continuation of U.S. application Ser. No. 15/024,924, filed on Mar. 25, 2016, which is a National Stage of International Application No. PCT/EP2014/070134, filed on Sep. 22, 2014, which claims priority to European Application No. 13185855.7, filed on Sep. 25, 2013, the contents of which are hereby incorporated by reference in their entirety.

The present invention relates to the scope of a food arrangement having a receptacle which is filled with a liquid food for clinical nutrition as well as to a method for producing and filling such a food arrangement.

When producing liquid food products for clinical nutrition, such as, for example, solutions for the enteral sector, the receptacle, which is filled with solution and closed, is subject to a final vapor sterilization. To this end, the receptacles, which are produced in particular as bottles or pouches, are heated with the enteral solutions in an autoclave after the filling process.

However, many constituents of the nutritional solutions are not sterilizable at high temperatures and/or their effectiveness, their chemical characteristics and/or their taste is impaired by the heat. Apart from this, many packaging materials are not suitable for sterilization at high temperatures and their physical, mechanical and/or chemical characteristics are impaired. In addition, the final autoclaving is time-consuming, space-consuming and cost-intensive.

A food arrangement which is fillable in this manner and finally sterilizable, i.e. after the filling process, is described in publication EP 0 830 874 B1. This describes a connector for packagings containing medical liquids which comprises a tubular connecting part for receiving a spike for the removal of the liquid. The connecting part is closed by way of a twist-off tamper-evident closure. A puncturable diaphragm is arranged in the connecting part. The diaphragm is also still closed or intact prior to the use of the packaging, i.e. with the tamper-evident closure not removed. Once the tamper-evident closure has been removed, the diaphragm is not punctured until the liquid is removed by the spike.

The object underlying the invention is to create a receptacle for receiving an enteral nutritional solution and a method for producing such a filled receptacle, both of which reduce or even avoid the aforementioned disadvantages of the prior art.

Said object is achieved by the subject matter with the features according to the independent claims. Advantageous embodiments are the subject matter of the dependent claims, the description and the drawings.

The present invention is based in general on the concept of providing a container for enteral food, the interior of which container, on the one hand, being closed in a sterile manner and, on the other hand, being closed hermetically in relation to the surrounding area. Sterile, enteral food is then filled into the sterile interior of the container under aseptic conditions. Finally, the container is closed under aseptic conditions. As a result, a container is provided with germ-free food without the previously necessary final autoclaving of the entire filled receptacle being necessary.

According to a first aspect, the present invention relates to a food arrangement having a receptacle which is filled with a liquid, sterile food, a connector which is inserted onto or into the receptacle with a punctured, for example open diaphragm which is arranged, for example injected or pre-mounted, in a filling spout; and a closure, here preferably as a tamper-evident closure, which is joined to the connector and closes the filling spout of the connector, preferably aseptically. The closure or tamper-evident closure is still in its original state, i.e. it has not yet been removed. The receptacle has not yet been opened. The technical advantage achieved as a result, for example, is that a germ-free food arrangement is provided without a final autoclaving of the entire filled receptacle being necessary.

Prior to filling with a filling nozzle, the diaphragm is punctured or broken open or torn open or cut open and as a result is opened by means of the filling nozzle itself or by a separate component, in particular a separate mandrel.

In one embodiment, the diaphragm remains open after opening and/or filling. The diaphragm is a non-reclosable diaphragm in said development. It is preferably substantially plastically deformable.

According to one embodiment, the diaphragm is a plastics material diaphragm. The technical advantage achieved as a result, for example, is that it is able to be produced in a simple and energy-saving manner.

According to a further embodiment, the diaphragm is realized integrally with the filling spout. The technical advantage achieved as a result, for example, is that one assembly step is saved and the production of the food arrangement is simplified.

According to a further embodiment, the diaphragm is injected into the filling spout. The technical advantage achieved as a result, for example, is that the production process of the connector is simplified.

In a further, preferably alternative, embodiment, the diaphragm is closed after the puncturing and/or filling. The diaphragm in said development is a reclosable diaphragm. The operation of the puncturing can preferably also be considered for said diaphragm. The diaphragm is substantially elastically deformable, for example a rubber diaphragm. The diaphragm can be, for example, a pre-slotted diaphragm. The slot can extend continuously or only in portions through the diaphragm. In both variants, the diaphragm is closed prior to and after puncturing. The diaphragm can be inserted into the filling spout or can be pre-mounted in the filling spout.

According to a further embodiment, the receptacle is a plastics material pouch. The technical advantage achieved as a result, for example, is that a flexible container which is simple to handle is created. In particular, the pouch is a stand-up pouch.

According to a further embodiment of the invention, the connector includes a welding portion for welding the connector to the receptacle. The technical advantage achieved as a result, for example, is that a particularly reliable and tight join between the connector and the receptacle is able to be produced.

According to a further embodiment, the filling spout includes a circumferential latching groove for latching in the closure. The technical advantage achieved as a result, for example, is that a liquid-tight, air-tight and germ-tight covering of the filling spout is achieved simply by fitting the closure.

According to a further embodiment, the filling spout can include an external thread for screwing on the closure. The technical advantage achieved as a result, for example, is that releasing the closure in an unintentional manner is prevented.

The closure is formed according to the invention or preferably by a tamper-evident closure. The technical advantage achieved as a result, for example, is that a closure is used by means of which the tamper-evident originality of the food can be ensured.

According to a further embodiment, a reclosable septum is arranged between the diaphragm and the closure. As a result, the filling spout is sealed again once the solution has been removed and repeated removal of the solution is made possible. The reclosable septum can also be designated as a, preferably further, reclosable diaphragm.

According to a second aspect, the invention relates to a method for producing a food arrangement with a liquid food. The method includes the following steps: provide a receptacle for a liquid food with a connector which is inserted into or onto the receptacle and comprises a diaphragm, which hermetically seals an interior formed in the receptacle, wherein the interior of the receptacle is sterile or sterilized; sterilize at least one outside surface of the diaphragm of the receptacle which is provided with the sterile or sterilized interior, and in particular an inlet channel of the connector above the diaphragm, preferably in an aseptic environment; puncture or open the sterilized diaphragm in an aseptic environment; fill the receptacle with a sterile food by means of the connector with the sterilized and punctured diaphragm by means of a filling nozzle in an aseptic environment and close the filled receptacle by fitting a closure, here preferably as a tamper-evident closure, onto the connector with the punctured diaphragm in a or the aseptic environment. The technical advantage achieved as a result, for example, is that aseptic or sterile filling of the receptacle is achieved in a particularly simple and energy-saving manner and autoclaving, as a final method step, is or can be avoided.

The components or regions subject to or exposed to sterilization and/or the method steps carried out in a sterile environment are designated as sterile. The aseptic or germ-free state or the aseptic or germ-free environment is preferably defined by means of requirements or standards to be adhered to for enteral, clinical nutrition. Microbiological safety and a sufficiently long product shelf life have to be guaranteed. The, preferably substantially all the, microorganisms capable of reproduction are killed off after sterilization. The aim of aseptic production is to preserve the sterility of the food arrangement which is composed of sterilized components.

The pH value of the enteral food to be filled is within a range of between 6 and 7 in one development.

The closure cap is preferably prepared in a sterile state in the aseptic environment and is then fitted onto the connector. The aseptic environment can be an aseptic zone which is closed in relation to the surrounding area and in which just the connector or part of the connector of the receptacle to be filled is contained.

The receptacle to be provided and the inserted connector are provided as an empty receptacle. An empty receptacle is a receptacle which is not yet filled with the enteral nutritional solution. The receptacle to be provided is provided as a hermetically closed receptacle. The interior of the receptacle is closed in relation to the surrounding area.

In one embodiment, the diaphragm is punctured by the filling nozzle. The technical advantage achieved as a result, for example, is that the diaphragm is initially punctured and opened and then the receptacle is filled by way of the same component. In an alternative embodiment, the diaphragm can be punctured and consequently opened by way of a mandrel and then the receptacle is filled by way of the filling nozzle.

According to a further embodiment of the invention, the step of sterilizing the diaphragm includes sterilizing by means of a vapor blast and/or by means of hydrogen peroxide. The technical advantage achieved as a result, for example, is that particularly suitable means are used for sterilizing the diaphragm and germs are reliably killed off. The diaphragm, in this case, is sterilized in portions or entirely. The filling spout, in particular the inner region of the filling spout, is also sterilized in portions or entirely together with the diaphragm.

The method according to the invention described above and below for producing the food arrangement can be carried out with all the method steps at one location. The receptacle can also be produced initially at one location and the receptacle interior sterilized and only then transported to a filling installation at a different location.

According to a further embodiment, the method consequently includes the step of producing the receptacle to be produced by joining, preferably welding, the connector to the receptacle in order to produce a hermetically sealed join between the connector and the receptacle. The technical advantage achieved as a result, for example, is that ingress of germs at the join between the connector and the receptacle can be avoided in a particularly efficient manner. The interior of the receptacle is hermetically closed from the surrounding area.

According to a further embodiment, the method includes the step of sterilizing the produced receptacle in order to kill off germs inside the receptacle. The hermetically sealed interior of the receptacle can be provided in a germ-free manner as a result. The production and the filling of the receptacle can take place at different times and/or at different locations.

In one possible development, the sterilizing of the produced receptacle includes exposing the receptacle to radiation, preferably by means of ionizing radiation, and/or to gas in order to kill off germs inside the receptacle. The technical advantage achieved as a result, for example, is that germs are killed off in a particularly efficient and energy-saving manner.

According to a further aspect, the invention relates to an empty pouch as a receptacle for an above-described food arrangement according to the invention and/or for an above-described method according to the invention. The empty pouch includes a connector which is closed by way of a piercable diaphragm which is preferably integrally realized with the connector such that an interior of the empty pouch is closed and wherein the interior of the empty pouch is germ-free. An empty pouch is a pouch which is not yet filled with enteral nutritional solution. The interior of the empty pouch is closed in relation to the surrounding area. The outside surface of the pouch can be exposed to the environment, the interior of the empty pouch, however, remains germ-free. Under ambient conditions and without being packaged separately, such an empty pouch can be transported, for example, to a filling installation which is situated at a different location. The empty pouches can be transported, for example, at a high packing density in the folded state and consequently in a cost-efficient manner.

Further embodiments are explained in more detail below with reference to the accompanying drawings, in which:

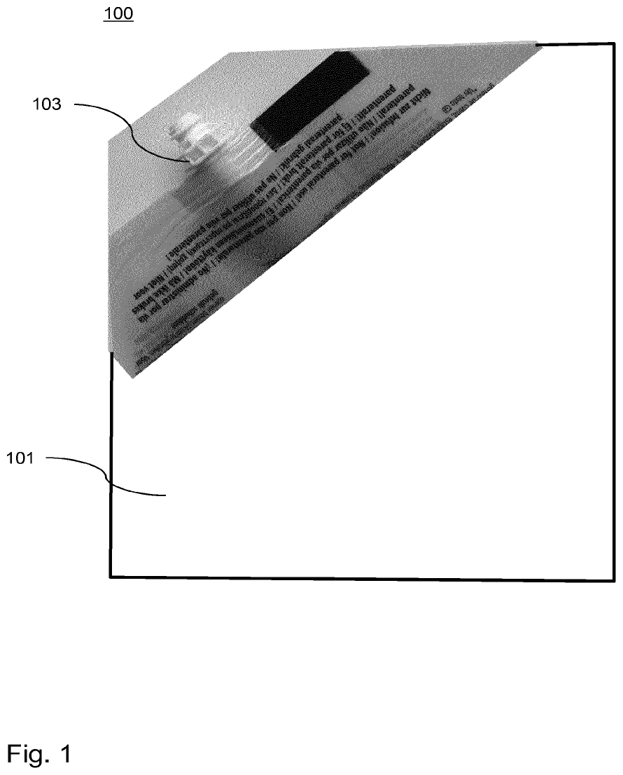

FIG. 1 shows a view of a receptacle with a connector inserted;

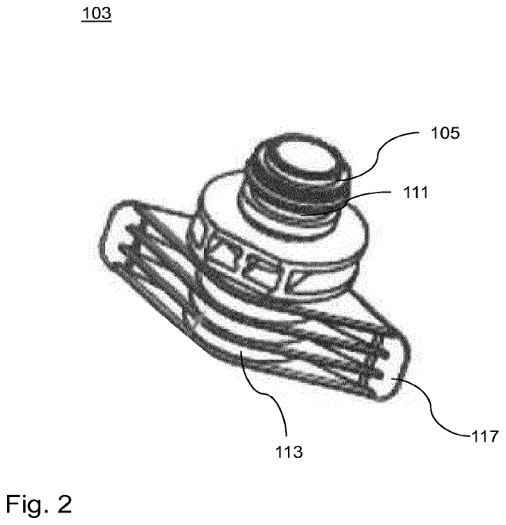

FIG. 2 shows a perspective view of a connector;

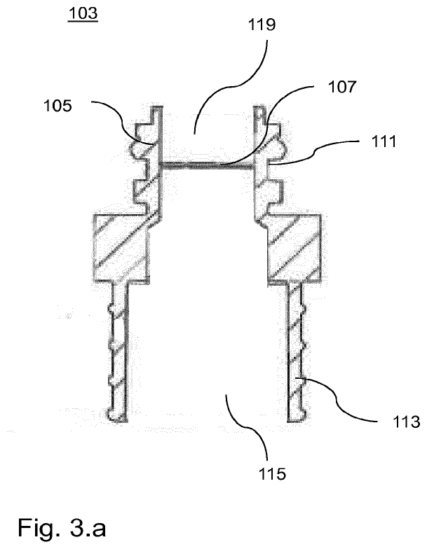

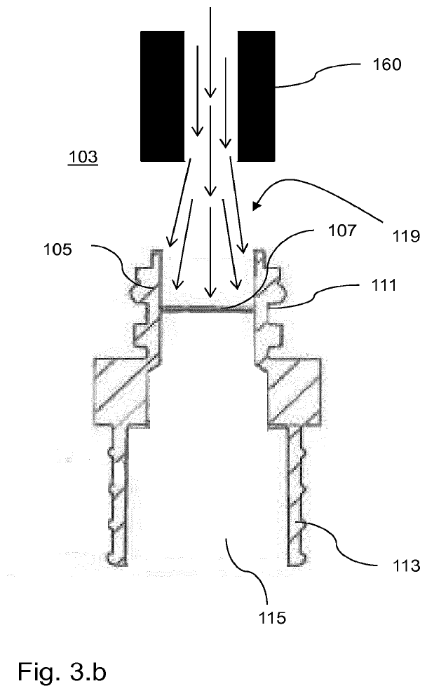

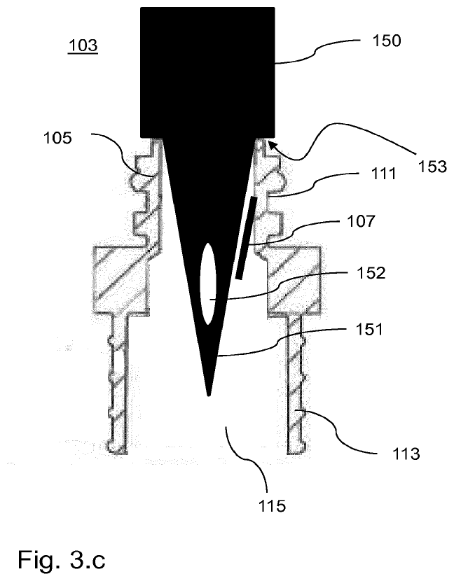

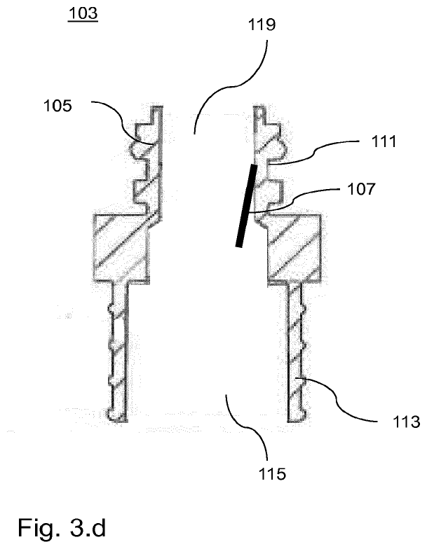

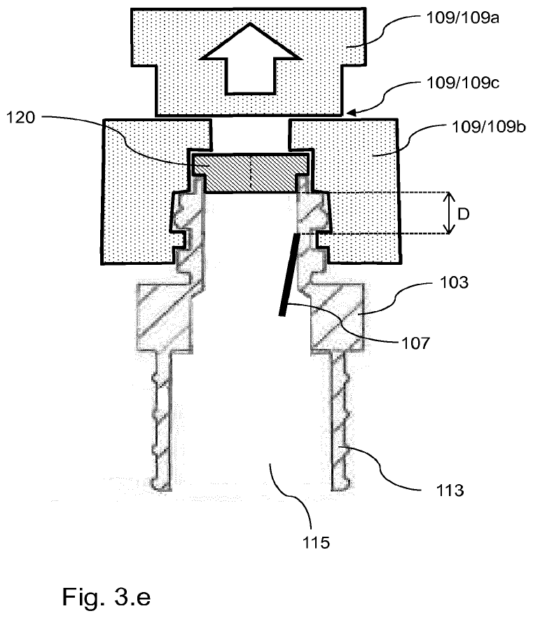

FIGS. 3.a to 3.e show a schematic cross sectional view through the connector with an injected diaphragm which is not open (FIG. 3.a), during cleaning with the diaphragm not yet opened (FIG. 3.b), with the diaphragm punctured and open and with the filling nozzle introduced (FIG. 3.c), with the diaphragm punctured and open and the filling nozzle removed (FIG. 3.d) and with the diaphragm punctured and open and the closure fitted (FIG. 3.e);

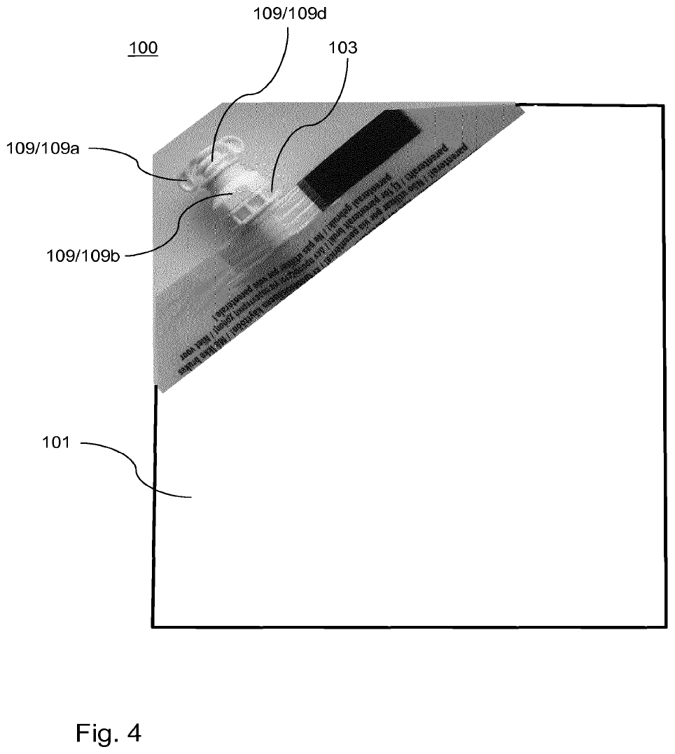

FIG. 4 shows a view of a food arrangement; and

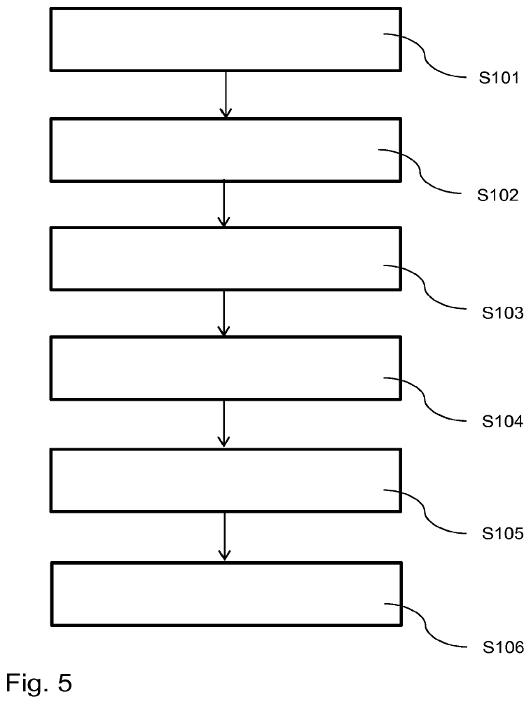

FIG. 5 shows a flow diagram of a method for aseptic filling of the food arrangement.

FIG. 1 shows a food arrangement 100 which is still unfilled which has a connector 103 and a receptacle 101. The portion of the receptacle 101 with the inserted connector 103 is shown here as a photograph, the rest of the receptacle 101, in contrast, is shown schematically. The connector 103 is a connection system which, for example, on the one hand serves for the mechanical connection and link to a filling device (not shown) in order to fill the receptacle 101 with food and, on the other hand, serves for the removal of the food. The connector 103 is connected in a liquid-tight manner to the receptacle 101 for this purpose. Apart from this, the connector 103 serves for the fitting of a closure 109 in order to avoid ingress of germs once the receptacle 101 has been filled. The connector 103 is formed, for example, by a plastics material molding.

The receptacle 101 is shown as a plastics material pouch. The side edges of the plastics material pouch 101 are welded. The connector 103 is also welded into the side edges of the plastics material pouch 101. The receptacle can generally be formed by any device which is capable of receiving liquid food and which can be sterilized from the outside, such as, for example, a container, a plastic bottle, a plastic tank or a rubber pouch, and which in particular meets the requirements for storing clinical enteral food. The liquid food is situated in the receptacle 101. The liquid food is, for example, a solution for enteral nutrition. Contamination of the enteral food with germs should consequently be prevented as much as possible so as not to cause infection in a patient.

FIG. 2 shows a perspective view of the connector 103. The connector 103 includes a filling spout 105 with a circumferential latching groove 111, a welding portion 117 and an inside filling spout 113 with spacer wings. The filling spout 105 serves for filling the receptacle 101 by means of a filling device 150 (not shown here) and/or for removing the food out of the receptacle 101 by means of a spike which is not shown here. During filling, a filling nozzle, for example, is guided into the interior of the filling spout 105, by means of which the food is filled into the receptacle 101. Once the receptacle 101 has been filled, a closure 109 is placed onto the filling spout 105 and it latches in the latching groove 111 such that the connector 103 is hermetically closed and the food is not contaminated by germs. In another embodiment of the connector 103, which is not shown, the filling spout 105, however, can include an external thread such that the closure is able to be screwed on.

The welding portion 117 serves for welding the connector 103 to the receptacle 101 such that a hermetically sealed join which prevents ingress of germs is generated at said point also.

The inside filling spout 113 of the connector 103 is located in the edge region of the receptacle 101 and also serves for introducing the food. The inside filling spout 113 extends in the interior of the welding portion 117. The welding portion 117 includes two spacer wings which prevent the receptacle 101, which is, for example, formed here by a plastic pouch, from extending in front of the inside filling spout 113 and blocking it. For this purpose, so-called spacer ribs are arranged on the spacer wings.

FIGS. 3.a to 3.e each show a schematic cross sectional view through the connector 103 in different views or method stages.

FIG. 3.a shows a cross sectional view through the connector 103 shown in FIG. 2. In its interior, the filling spout 105 of the connector 103 includes a closed diaphragm 107. The diaphragm 107 is a separating layer. It closes the filling spout 105. It prevents germs being able to ingress into the unfilled receptacle 101 with the connector 103 inserted.

The diaphragm 107 is shown here in the embodiment of a plastics material diaphragm. The plastics material diaphragm 107 can be injected into the filling spout 105. The plastics material diaphragm is realized integrally with the connector 103 in this case.

The welding portion 117 of the connector 103 is formed around the inside filling spout 113. The latching groove 111 is situated here approximately at the same height as the diaphragm 107. In the example shown, the inlet channel 119 of the filling spout 105 is narrower than the outlet channel 115 of the inside filling spout 113. As a result, a filling nozzle can be introduced easily and without obstructions into the connector 103.

The filling nozzle can be guided through the narrower inlet channel 119. The liquid food is able to flow substantially unobstructed into the container 101 through the wider outlet channel 115.

The cleaning, in particular sterilizing, carried out prior to opening the diaphragm 107 is shown in FIG. 3.b. At least the interior of the connector 103, which is formed by the outside surface of the diaphragm 107 and the inside surface of the inlet channel 119, is cleaned, in particular sterilized. A cleaning nozzle 160 is used for this purpose. Water vapor and/or hydrogen peroxide preferably flows out of the cleaning nozzle 160 for sterilizing purposes. As a result, germ-free filling can be guaranteed. The outside surfaces of the connector can also be cleaned at least in part. FIG. 3.c shows the connector 103 from FIG. 3.b with a punctured, open diaphragm 107 and the filling nozzle 150 inserted. In said development, the diaphragm 107 is punctured by means of the filling nozzle 150 such that an opening is formed in the diaphragm 107 or in the connector 103. The diaphragm 107 is displaced to the side. The filling of the container 101 by means of the filling nozzle 150 is then effected. To this end, the filling nozzle 150 has an outlet opening 152 for the liquid food in the front region which projects into the filling spout 105. The filling nozzle 150 is in the shape of a mandrel 151 at least in portions in the front region as the filling nozzle 150 is used here both for filling the receptacle 101 and for opening the diaphragm 107. A thickness of the diaphragm 107 is, for example, between 0.05 mm and 0.5 mm, preferably between 0.1 mm and 0.3 mm. Said thickness of the diaphragm 107 provides sufficient tightness on the one hand. On the other hand, a diaphragm 107 with such a thickness is easily able to be punctured by the filling nozzle 150. The filling nozzle 150 provides a stop 153 in this case which comes to abut against the end faces of the connector 103. The stop 153 preferably abuts in a sealing manner against the end faces of the connector 103. As a result, the interior of the receptacle 101 is shielded again. The liquid food can be filled into the receptacle 101 under pressure, in particular without influencing the environment by the liquid food.

FIG. 3.d shows the connector 103 with the diaphragm 107 punctured and open after the filling operation. The filling nozzle 150 has been removed. The diaphragm 107, in said embodiment, is a non-reclosable diaphragm. The diaphragm 107 has been punctured, here broken open. As a result, a passage has been provided in the connector 103. The diaphragm 107 is, however, still connected to the connector 103. The diaphragm 107 is preferably movably joined to the filling spout 105 or fastened on said filling spout. Said join can be, for example, an articulated join. A type of film hinge can be formed. In a development not shown here, once the filling nozzle 150 has been removed, the diaphragm 107 is able to fold upward again into the initial position and form a type of closure. In a further development which is not shown here, the diaphragm 107 can be closed again once the filling nozzle 150 has been removed. In such an embodiment the diaphragm 107 is a reclosable diaphragm.

After the filling process, the closure 109 is fitted in an aseptic environment. This is shown schematically in FIG. 3.e. An aseptic environment can be provided, for example, by clean room conditions and/or a defined atmosphere of a gas, such as, for example, nitrogen. The aseptic environment can be provided in a room that is closed in relation to the surrounding area and/or by a defined gas stream. The entire food arrangement 100 or only parts thereof, in particular the connector 103, can be arranged in said aseptic environment. If, for example, only the connector 103 and an adjoining part of the receptacle 101 or only the connector 103 or even only a portion of the connector 103 is arranged in the aseptic environment, a filling process that requires reduced amounts of time, space and cost can be made possible. The cleaning of the connector 103, the opening of the diaphragm 107, the filling of the receptacle 101 with the nutritional solution and/or the closing of the connector 103 can be carried out in the aseptic environment.

The closure 109 is a closure cap which is fitted or screwed onto the connector 103. A self-sealing, reclosable septum 120 is arranged between the connector 103 and the closure 109. The septum 120 is produced from an elastic material. The septum 120 can be provided, for example, in the interior of the closure 109. The septum 120 is preferably held in a clamping manner between the closure cap 109 and the connector 103, in particular the end faces of the connector 103. The septum 120 enables the connector to be reclosed once the closure 109 has been opened. In order to facilitate the opening of the septum 120, for example by means of a spike, the septum 120 can be slotted at least in portions. In one embodiment, the septum 120 is slotted continuously from outside to inside.

The closure 109 is preferably a tamper-evident closure. The tamper-evident closure is a closure, by way of which the authenticity and integrity of the food arrangement 100 and of the food is able to be judged. The tamper-evident closure 109 includes here, on the one hand, a base part 109b for the latching-in and snapping-in connection to the connector 103. On the other hand, the tamper-evident closure includes a break-off and/or twist-off part 109a which is connected to the base part 109b by means of a predetermined breaking point 109c. As a result of breaking off and/or twisting off the break-off and/or twist-off part 109a, said part can be removed from the base part 109b, thereby exposing the septum 120. By means of a spike which is plunged into the septum 120, a fluid connection can be provided, for example to a bridge set and/or a gastric or nasal tube, such that the liquid food is able to be removed from the pouch 101.

The distance D between the bottom surface of the septum 120 and the top surface of the diaphragm 107 is dimensioned such that the function of the reclosing of the septum 120 is not impaired or is not impaired significantly. In addition, the diaphragm 107, which has already been opened beforehand, in particular by the resetting force formed by the film hinge, supports the mounting arrangement of the spike by the septum 120. The distance D, for this purpose, is in particular within a range of between 3 mm and 20 mm, preferably between 5 mm and 10 mm.

The closure 109 can additionally include a removal device for removing the food from the receptacle 101, for example an outlet or tap which is actuatable by a user.

FIG. 4 shows the entire food arrangement 100 after the receptacle 101 has been filled and after the closure 109 has been fitted onto the connector 103. In said state, ingress of germs into the connector 103 can be prevented by the closure 109. The portion of the receptacle 101 with the inserted connector 103 and the mounted closure 109 is shown here as a photograph, the rest of the receptacle 101, in contrast, is shown schematically. The closure 109 comprises another thread 109d. As a result, a removal system, such as, for example, a bridge system with a spike, can be fastened securely by screw-connection on the connector 109 or the receptacle 101.

FIG. 5 shows a flow diagram of a method for aseptic filling of the food arrangement 100.

In a first step S101, the connector 103, which includes the diaphragm 107, and the receptacle 101 are welded together. The interior of the receptacle 101 is hermetically sealed by the diaphragm 103 which is present in the connector 107. For example, the connector 103 is welded to a plastics material pouch such that the plastics material pouch is hermetically tight. The still empty interior of the receptacle 101 is hermetically sealed. It is possible to produce the receptacle 101 under non-aseptic conditions. Consequently, the interior of the produced receptacle 101 is initially not germ-free.

In a second step S102, the empty receptacle 101 with the connector 103 welded on is sterilized in order to kill off or inactivate germs in the interior of the receptacle 101. The use of radiation sterilization by means of beta and/or gamma rays is advantageous as said rays penetrate the receptacle 101 and in a reliable manner kill off the germs on the outside and inside surfaces and, where applicable, in the interior of the receptacle 101. As an alternative to this or in addition to it, the interior of the receptacle 101 can be sterilized by means of ethylene oxide gas (EtO gas). In general, however, it is also possible to use any other sterilization methods which are capable of killing off germs in the interior of the receptacle 101. In its interior, the receptacle 101 is consequently sterile and germ-free. Its outside surface, however, can come into contact with the environment. This does not impair the interior of the receptacle 101. The receptacle 101 can be packaged in a non-hermetic manner and be transported to a filling installation at a different location. In the embodiment as a pouch, the receptacles 101 can be transported, for example, at a high packing density of pouches in the folded state and consequently in a cost-efficient manner. The providing of the receptacle 101 for sterilizing S103 the diaphragm 107 of the receptacle 101, as explained below, includes the two aforementioned steps S101 and S102.

Prior to supplying the receptacle 101 to the filling device, the receptacles 101 are unpacked. In this case, in particular the head and the filling region of the connector 103 are briefly open in an unprotected manner and can consequently be contaminated. The interior of the receptacle 101 nevertheless continues to be air-tight or hermetically sealed as a result of the diaphragm 107 and remains sterile.

Consequently, in a third step S103 prior to the filling process, the diaphragm 107 and the filling spout 105 are sterilized from the outside. This is effected, for example, as a result of the diaphragm 107 and the interior of the filling spout 105 being treated with a germicidal agent. For example, the outer or outside regions of the connector 103 are pretreated by means of a vapor blast or with hydrogen peroxide. In general, however, it is also possible to use any other sterilization methods which are capable of killing off germs in the interior of the filling spout 105 and on the diaphragm 107. The sterilization can be limited to the named regions.

In a fourth step S104, prior to the filling operation, the diaphragm 107 is punctured by means of the filling nozzle 150 in an aseptic environment such that the receptacle 101 is able to be filled. As a result of the puncturing of the diaphragm 107 by means of the filling nozzle 150, the path for filling the receptacle 101 is exposed. The aseptic environment can be present at the time of filling or even when sterilizing the receptacle 101 and/or the diaphragm 107.

In a fifth step S105, the previously sterilized receptacles are filled with the food in the filling device under aseptic conditions. The enteral nutritional solution is sterilized or provided in germ-free state and is filled into the container in said state.

In a sixth step S106, the receptacle 101 is closed by mounting the closure 109 onto the connector 103 under aseptic conditions. This can be effected, for example, by fitting a closure cap which is at the same time suitable for removing the food from the receptacle 101.

As a result of said method, aseptic filling of food is achieved without the food arrangement having to be subject to a final vapor sterilization.

The individual features explained in the description and shown in the figures can be combined together in a different manner in order to realize the advantageous effects thereof at the same time. The invention is not limited to the exemplary embodiments explained in connection with the drawings, but is provided by the protective scope of the claims.

### LIST OF REFERENCES

100 Food arrangement
101 Receptacle
103 Connector
105 Filling spout
107 Diaphragm
109 Closure
109a Break-off or twist-off part of the closure
109b Base part of the closure
109c Predetermined breaking point between the base part and the break-off or twist-off part
109d Thread
111 Latching groove
113 Inside filling spout
115 Outlet channel
117 Welding portion
119 Inlet channel
120 Septum or reclosable diaphragm
150 Filling nozzle or filling spout
151 Mandrel or puncturing element on the front side of the filling nozzle
152 Outlet opening in the filling nozzle for the food
153 Stop of the filling nozzle
160 Cleaning device or cleaning nozzle
S101 Produce the receptacle
S102 Sterilize a receptacle
S103 Sterilize the diaphragm
S104 Puncture the diaphragm for filling the receptacle
S105 Fill the receptacle
S106 Close the connector hermetically in an aseptic environment

1. (canceled)

2. An apparatus for enteral feeding of a patient, said apparatus comprising
a quantity of sterile enteral nutrition solution, said quantity having been selected for feeding said patient,
a pouch that contains said quantity of sterile enteral nutrition solution, said enteral nutrition solution having been delivered by a filling nozzle during filling of said pouch,
a connector inserted into said pouch, said connector comprising a filling spout that receives an enteral spike, said enteral spike being configured for enteral feeding and through which said enteral nutrition solution is withdrawn during enteral feeding,
a diaphragm that is integral with said filling spout, said diaphragm having been punctured by said filling nozzle during filling of said pouch,
a tamper-evident closure that closes said filling spout, said tamper-evident closure comprising a break-off part and a base part that is in engagement with said connector, and wherein said base part comprises a thread for engagement with said enteral spike during enteral feeding, and
a septum through which said enteral spike is plunged during withdrawal of said enteral nutrition solution, said septum being a self-sealing and reclosable septum that is disposed between said diaphragm and said closure.

3. The apparatus of claim 2, wherein said diaphragm is flat.

4. The apparatus of claim 2, wherein said diaphragm has a thickness that is between 0.05 millimeters and 0.5 millimeters.

5. The apparatus of claim 2, wherein said pouch is a stand-up pouch.

6. The apparatus of claim 2, wherein a film hinge enables a portion of said pierced diaphragm to move relative to said filling spout.

7. The apparatus of claim 2, wherein said diaphragm joins said filling spout at a film hinge that causes a resetting force that supports said spike when said spike has been inserted through said septum.

8. The apparatus of claim 2, wherein said filling spout comprises a circumferential latching groove for engaging said closure.

9. The apparatus of claim 2, wherein said connector comprises a welding portion that includes spacer wings and spacer ribs arranged on said spacer wings, wherein an inside filling-spout extends into said welding portion.

10. The apparatus of claim 2, wherein said diaphragm joins said filling spout at an articulated joint

11. The apparatus of claim 2, wherein said filling spout comprises an external thread for screwing on said closure.

12. The apparatus of claim 2, wherein the septum is slotted in portions thereof.

13. The apparatus of claim 2, wherein the septum is slotted continuously from outside to inside.

14. The apparatus of claim 2, wherein said filling spout comprises an inlet channel and an outlet channel, wherein said spike enters said inlet channel before reaching said outlet channel, and wherein said inlet channel is narrower than said outlet channel.

15. The apparatus of claim 2, wherein said septum and said diaphragm are separated by between three millimeters and twenty millimeters.

16. The apparatus of claim 2, wherein, when said spike is inserted into said filling spout, said diaphragm exerts a force on said spike.

17. The apparatus of claim 2, wherein said diaphragm is displaced toward a side of said filling spout.

18. The apparatus of claim 2, wherein said filling spout comprises a circumferential latching groove at the same height as said diaphragm.

19. The apparatus of claim 2, wherein said diaphragm is a non-reclosable diaphragm.

20. The apparatus of claim 2, wherein said septum comprises an elastic material.

21. The apparatus of claim 2, wherein said receptacle comprises edges and said connector is disposed at said edge.

22. The apparatus of claim 2, wherein said diaphragm is a plastic diaphragm.
